(19) United States
(12) Patent Application Publication
(10) Pub. No.: US 2026/0237991 A1
(43) Pub. Date: Aug. 13, 2026

(54) AN ELECTRICAL CONDUCTOR WITH VARYING AREA MOMENT OF INERTIA

(71) Applicant: KK WIND SOLUTIONS A/S, Ikast (DK)

(72) Inventors: Jorgen Dahl Vestergaard, Kibaek (DK); Poul Thing, Ikast (DK); Bjorn Rannestad, Aalborg (DK)

(21) Appl. No.: 19/469,324

(22) PCT Filed: Mar. 22, 2024
(86) PCT No.: PCT/DK2024/050069

§ 371 Date: Sep. 25, 2025

(30) Foreign Application Priority Data
Mar. 28, 2023 (DK) PA202370156
Apr. 27, 2023 (DK) PA202370206
May 26, 2023 (DK) PA202370258
Jul. 7, 2023 (DK) PA202370369

(51) Int. Cl. H02G 5/08; H01B 5/04; H02B 1/21; H02B 1/56; H02G 5/10

(52) U.S. Cl. CPC H02G 5/08; H01B 5/04; H02B 1/21; H02B 1/56; H02G 5/10

(57) ABSTRACT

An electrical conductor includes a first end and a second end. The electrical conductor is configured for being fastened to a support structure at one or more fastening areas. The one or more fastening areas separate the electrical conductor in two or more conductor sections, each having an area moment of inertia with respect to a reference axis. A first conductor section of the two or more conductor sections has a first area moment of inertia. A second conductor section of the two or more conductor sections has a second area moment of inertia with respect to the reference axis, which is different from the first area moment of inertia.

### FIELD OF THE INVENTION

The invention relates to an electrical conductor having a first and second conductor section with varying area moment of inertia, a high-power electrical system comprising such electrical conductor and a method of designing such electrical conductor.

### BACKGROUND OF THE INVENTION

Electrical conductors in the art are carrying high currents in high-power electrical systems. Therefore, such electrical conductors are having a high masse and cross-sectional area to ensure compliance with requirements to currents to be conducted. The high mass and cross-sectional area however, makes the busbars rigid, difficult to handle manually and expensive.

### SUMMARY OF THE INVENTION

The inventors have identified the above-mentioned problems and challenges related to electrical conductors and solved these problems by the present invention as described below.

In an aspect, the invention relates to an electrical conductor comprising a first end and a second end, said electrical conductor is configured for being fastened to a support structure at one or more fastening areas, wherein said one or more fastening areas separate said electrical conductor in two or more conductor sections each having an area moment of inertia with respect to a reference axis. Wherein a first conductor section of said two or more conductor sections has a first area moment of inertia. Wherein said electrical conductor is characterized in that a second conductor section of said two or more conductor sections has a second area moment of inertia with respect to said refence axis which is different from said first area moment of inertia.

This advantageous in that it has the effect that such electrical conductor is designed to withstand different forces acting at different locations/sections along the electrical conductor. Such forces may be caused by a short circuit in an electric system in which the electrical conductor is used to establish a current path.

The freedom of designing one section of a conductor different from another is advantageous in that the sum of material used to manufacture the electric conductor can be reduced. Further, other feature of the conductor may be optimized such as with respect to cooling and deflection, etc.

The area moment of inertia of a conductor section should be understood as the resistance against movement of the conductor section from a force acting on the conductor section from a given direction. In case of a short circuit, the force may be applied from a further electrical conductor that is installed next to (such as parallel in the same plane, perpendicular or with an angle between two conductors in two different planes, etc) the electrical conductor. As two such electrical conductors may not need to run parallel along their entire lengths, there might be material to spare by changing area moment of inertia of different conductor sections of both the electrical conductor and the further electrical conductor.

A reference axis of the conductor may be defined as an axis going through the centroid of the conductor and an area moment of inertia may be calculated relative to such reference axis.

The determination of area moment of inertia of a conductor section is preferably done by a computer program based on 3D CAD models of the electrical conductor. This is e.g. to ease calculations and to be able to account for force contributions from other sources than the neighbouring conductors. One example of such contribution may be from the way the conductor is fixed to the support structure.

One simple way of determining an area moment of inertia of a conductor section is to calculate on the conductor as if the conductor section is fixed in both ends and a force is applied at the middle of the conductor section. A bending moment then occur as consequence of the impact from the force and with a maximum allowable stress of the conductor section material, the area moment of inertia can be determined. From this, dimensions of the conductor section can be determined.

It should be noted that the area moment of inertia is different from the rotational area of inertia. Thus, the area moment of inertia is determined with reference to a neutral axis of the conductor section. This is to avoid including contributions from rotational moment of inertia in the calculation of the required area moment of inertia.

An electrical conductor should be understood as a cable or a busbar that is conducting an electrical current in an electrical high-power system. Such conductor may be provided inside or outside an electrical cabinet.

In an exemplary embodiment of the invention the first area moment of inertia and said second area moment of inertia is determined relative to the orientation in space of said conductor sections.

This should be understood as if two conductor sections are having the same geometry, but one is twisted 90 degrees, then the point/orientation from where the force is acting is also twisted 90 degrees and the required area moment of inertia to withstand this force is the same in the two conductor sections.

In an exemplary embodiment of the invention the area first moment of inertia and said second area moment of inertia is determined relative to a fixed direction of a force acting on said conductor sections.

This should be understood as if two conductor sections are having the same geometry, but one is twisted 90 degrees to the other and the point/orientation from where the force is acting is maintained, then the required area moment of inertia required to withstand this force is not the same in the two conductor sections.

In an exemplary embodiment of the invention the area moment of inertia of a conductor section varies with a bending moment distribution of said conductor section.

The bending moment may change along the conductor section based on expected impact from a force e.g. from a short circuit, vibrations, etc. Thus, the conductor section may be designed with an areas moment of inertia providing a stress which is able to withstand this varying bending moment. In this way, the area moment of inertia may vary along a conductor section. Such variation of area moment of inertia may be provided by a change of geometry of the conductor section. It should be mentioned that the varying area moment of inertia may be continuous or discrete (in steps). Continuous varying area moment of inertia may be facilitated by manufacturing the conductor section by an additive manufacturing process.

In an exemplary embodiment of the invention the electrical conductor is conducting one phase of a plurality of phases of a multiphase electric high-power system.

Such multiphase electric high-power systems may include three or more individual conductors each conducting the current of a phase. An example of a electric system having more than three phase could be a system comprising different filters such as a 5 and a 2.5 kHz filter, a system having high power conductors/components (operating with currents in the kilo hertz area) and conductors/component operating with currents below e.g. 32 A, etc.

When conductors of two independent (galvanic separated) electric systems are passing by each other in an electric cabinet, forces from a short circuit in one system may impact the other. Thus, this is an example of a complex situation where a computer program is needed to determine area moment of inertia required to withstand forces from a short circuit.

In an exemplary embodiment of the invention the electrical conductor is a first electric conductor of a two or three phased electric high-power system wherein each of said two or three phases is conducted by an individual second electric conductor and an individual third electric conductor each comprising conductor sections separated by one or more fastening areas.

Individual electric conductors should be understood as conductors that are galvanic isolated from each other. It should be mentioned that an electric cabinet comprising the electric system may in certain situations act as a second electrical conductor.

In an exemplary embodiment of the invention the second and/or third electric conductor is configured for being fastened to said support structure at said one or more fastening areas, wherein a first conductor section of said second and/or third electric conductor of said two or more conductor sections has a first area moment of inertia, and wherein a second conductor section of said second ad/or third conductor sections has a second area moment of inertia which is different from said first moment of inertia.

This is advantageous in that it has the effect, that the conductor sections of the first, second and third electrical conductors may be designed with a required moment of inertia taking into account impact/forces that may occur from each other in case of a short circuit. This should be understood as one conductor section of a first electrical conductor may be designed e.g. based on information of distance to a conductor section of a second electrical conductor and short circuit current in the second electrical conductor.

It should be mentioned that regulation of areas moment of inertia may be done by reducing/increasing of thickness/used material of the conductor i.e. change geometry and dimensions of conductor section of conductor branches hereof. Hence, if space is limited, material can be added to the conductor section to increase thickness of the conductor section where space is limited and thereby increase the area moment of inertia required to withstand the increased forces occurring from a short circuit at this point as consequence of the conductors being moved closer together.

In an exemplary embodiment of the invention the electrical conductor is part of a distribution system of an electric panel supplying electric components with electrical power via auxiliary electrical conductors.

In an exemplary embodiment of the invention the length of said first conductor section is different from length of said second conductor section.

This is possible because the different conductor sections of a conductor according to the present invention are designed with different area moment of inertia and thus along some parts of the conductor the distance between fastening points (to support structure) can be longer than along other parts of the conductor i.e. fastening points and time for fastening may be reduced. The design of the conductor according to the present invention strives to balance the number of mounting points and the cross-sectional area of the conductor. Hence, the closer together the mounting points are, the smaller cross-sectional areas (reduced aera moment of inertia) and vice versa.

In an exemplary embodiment of the invention the conductor section comprises mass in excess of what is needed to conduct the nominal current of said conductor section.

This is advantageous in that it has the effect, that the area moment of inertia of a conductor branch of a conductor section/of a conductor section is increased and thereby this part of the conductor is able to conduct short circuit currents without the risk of being disintegrated, cracking, split into parts, flung out of the electric cabinet, burned away, etc.

In an exemplary embodiment of the invention the conductor section comprises a first section part and a second section part, wherein said first section part is a current conducting part forming a main current path through said conductor section and wherein said second section part is a conductor support structure part increasing areas moment of inertia for said conductor section.

This is advantageous in that it has the effect, that the optimal current path can be chosen without compromising the area moment of inertia by compromising the structural stability also referred to the resistance to bending of the conductor section.

In an exemplary embodiment of the invention the electrical conductor comprising a conductor support structure which is monolithically formed from said electrical conductor.

In an exemplary embodiment of the invention the conductor support structure is non-parallel to the current path from said first end to said second end of said electrical conductor.

The current path through the electrical conductor should be understood as the way, the current is choosing/conducted from the first to the second end of the electrical conductor i.e. typically the shortest way. Accordingly, a conductor support structure which is not parallel to the current path may be provided to increase areas moment of inertia and thereby the strength of the electrical conductor and not necessary to conduct current. Thus, such conductor support structure may be considered as additional material having the purpose of increasing structural stability and e.g. also cool the electrical conductor.

In an exemplary embodiment of the invention the conductor support structure is an electrically non-conducting support structure.

This is advantageous in that it has the effect, that the support structure can be supporting the electrical conductor and thereby increase area moment of inertia of the conductor e.g. by establishing a connection between the electrical conductor and the electrical cabinet, between the electrical conductor and a further electrical conductor,

In an exemplary embodiment of the invention the conductor support structure is at least partly enveloping said electrical conductor.

Partially enveloping should be understood as increasing the area moment of inertia of the conductor by providing a conductor support structure around the electrical conductor. Such conductor support structure may be a lattice structure enveloping the electrical conductor at least one forth, two forth or three forth of the circumference of the conductor. The part covered depends on the expected direction of the force acting on the current e.g. from a short circuit, the distance to a neighbouring electrical conductor etc.

In an exemplary embodiment of the invention the conductor support structure is conducting heat away from the current part defining part of said electric conductor.

This is advantageous in that it has the effect that the conductor support structure has the dual function of cooling the electric conductor and increasing the structural stability and thereby the area moment of inertia of the electrical conductor.

In an exemplary embodiment of the invention the first conductor section has a first geometry and wherein said second conductor section has a second geometry, wherein said first geometry is different from said second geometry.

This is advantageous in that it has the effect, that by way of geometry of the conductor sections and thereby of a part of the electrical conductor, the area moment of inertia is defined. Thereby the behaviour of the electrical conductor in response to a short circuit current may be predetermined. An example of such behaviour may be burning over as a fuse in a predetermined conductor section or deforming in a conductor section designed as a deformation section.

The behaviour of the electrical conductor in case of a short circuit may be no change to the physical conductor i.e. it is capable of conducting or withstand the forces occurring from the massive short circuit current. Another behaviour may be heating up one conductor section more than another conductor section. Yet another behaviour may be burning over and thereby acting as a melting fuse.

In an exemplary embodiment of the invention the first geometry and/or said second geometry is selected from the list comprising: a cylindrical geometry, a multi-angular geometry, a lattice geometry and a bionic geometry.

It is advantageous to have different geometries along the electrical conductor in that each of these geometries may have different moment of inertia. Thus, the electrical conductor may be optimized to withstand forces acting on the electrical conductor from different directions. Accordingly, depending on e.g. distance and orientation of a conductor to a neighbouring conductor the geometry of these conductors may be coordinated to together withstand forces of e.g. a short circuit current.

Further, this is advantageous in that these geometries may have different properties such as conducting current, providing strength and stability, conducting heat, etc. Thus, by a change of geometries the properties of the electrical conductor may change along the electrical conductor.

Hence, in an embodiment of the invention, the mere twisting and bending of a conductor having a square form is not considered a change of geometry, it is still a square formed geometry despite this type of modification. Similarly, an increase or decrease in dimensions, including cross-sectional area, is not considered a change in geometry, it is still a square formed geometry despite this type of modification. Hence, a change in geometry should be understood as a change from e.g. a square geometry to a cylindrical geometry. A conductor having a bionic design may however be considered to have a changing geometry as conductor branches hereof split and joint and change cross-sectional area constantly. On the other hand, a conductor having a lattice design is not considered to have a changing geometry.

Examples of a multi-angular geometry is a triangle, square, pentagon, etc.

In an exemplary embodiment of the invention a geometry of a conductor section of a first electrical conductor comprises a plurality of conductor branches and wherein a distance between at least two of said plurality of conductor branches to a second electrical conductor change along the length of said conductor section.

This is advantageous in that it has the effect, that the distance between current conducting electrical conductors/conductor branches is increased as much as possible and thereby the distance between the conducted current is increased leading to a reduction in force generated from a short circuit. This is especially advantageous to reduce requirement to moment of inertia of the conductors in a situation where e.g. as consequence of a narrow physical space, the two electrical conductors are physically brought closer to each other.

In an exemplary embodiment of the invention the conductor branches are twisted.

In an exemplary embodiment of the invention the conductor branches is physically connected via a high impedance connection.

This is advantageous in that it has the effect, that the structural stability of the geometry is increased making the electrical conductor more rigid and in that the number of points of fastening the conductor/conductor branches to the support structure is reduced.

The melting part of the electrical conductor is advantageous in that in this way, the electrical conductor acts as a safety circuit which may facilitate a reduction of current which is to be stopped by a circuit breaker. In fact, if the circuit breaker does not stop the circuit breaker fails, the melted conductor section may act as a fuse and stop current from running through the system.

In an exemplary embodiment of the invention at least one of said two or more conductor sections is a transition conductor section having two geometries.

A transition conductor section is advantageous in that it has the effect, that it facilitates change of moment of inertia along the conductor by changing the conductor geometry from one geometry to another geometry.

In an exemplary embodiment of the invention the first geometry comprises a conductor branch which is non-parallel to a current path between said first and second ends.

Such non-parallel current path is advantageous in that it has the effect, that it may increase the area moment of inertia and thus the strength/rigidness of the conductor to withstand a force from a predefined direction relative to the electrical conductor. As an example, could be mentioned that the first geometry includes a conductor branch having an angle to the current path between 0 degrees and 90 degrees, such as between 15 degrees and 75 degrees.

In an exemplary embodiment of the invention the conductor branch is monolithically formed as an outgrowth at a first part of a first conductor section and is monolithically united with a second part of said first conductor section.

In an exemplary embodiment of the invention the conductor branch is monolithically formed as an outgrowth from a first conductor section and is monolithically united with a second conductor section.

In an exemplary embodiment of the invention the electric conductor comprises a first fastening area and a second fastening area, wherein said first fastening area is configured for fastening said electrical conductor in a first direction and wherein said first fastening area is configured for fastening said electrical conductor in a second direction, wherein said second direction is different from said first direction.

This is advantageous in that thereby it is possible to design the direction of the bending/deflection of the conductor and also vary the moment of inertia from one conductor section to another conductor section leading to more flexibility in designing electrical layout inside e.g. an electrical cabinet.

In an exemplary embodiment of the invention the a first conductor section of said first electrical conductor and a second electrical conductor is physically located at least partly in parallel with a first distance therebetween, wherein a second conductor section of said first electrical conductor has a second distance to said second electrical conductor which is smaller than the first distance, and wherein an area moment of inertia of said second conductor section of said first electrical conductor is higher than an area moment of inertia of said first conductor section of said first electrical conductor.

Having as large a distance between two conductors is advantageous in that the area moment of inertia of the conductor can be reduced. If for some reason a distance between two conductors needs to be reduced, the area moment of inertia of the two conductors at that conductor section need to be increased to ensure operatable conductors after a worst-case short circuit.

A change of area moment of inertia could be made as suggested above by support structure, mass, geometry and distance.

In an exemplary embodiment of the invention the first conductor section of said first electrical conductor include two or more conductor sections, and wherein said second conductor section of said first electrical conductor include two or more conductor sections and wherein said second conductor section of said first conductor element has a higher frequency of fastening areas than said first conductor section of said first electrical conductor.

This is advantageous in that adding fastening areas and thus e.g. the number of mounting points in a given area increases the area moment of inertia of that areas which in this example is the second conductor section of the first conductor.

In an exemplary embodiment of the invention the first conductor section of a first electrical conductor has a first mass and a first distance to a first conductor section of a second electrical conductor and wherein a second conductor section of said first conductor electrical has a second mass and a second distance to a second conductor section of said second electrical conductor, wherein the weight of said second mass is higher than the weight of said first mass and wherein said second distance is less than said first distance.

This is advantageous in that it has the effect, that when the distance between two electrical conductors is decreasing, the area moment of inertia may be increased to compensate for the increased force from a short circuit current that follows the reduced distance between two conductors. The distance between two conductors may decrease if footprint of a cabinet in which they are installed dictates so.

In an exemplary embodiment of the invention the said first end and a conductor branch are monolithically connected so as to at least partly form said electric conductor.

An electric conductor may need to pass through e.g. a current sensor having a center hole with a diameter which smaller than the diameter of the second end. In this situation it is possible to insert the conductor through the hole before physically mounting the second end thereto.

In an exemplary embodiment of the invention the first end and said second end are monolithically connected so as to form said electric conductor in one piece.

This is advantageous in that it has the effect that an electric conductor having different area moment of inertia along its longitudinal axis/length/current path is possible to mount as one part and not as in the art as several individual parts which need to be interconnected. This also leads to a reduced time of mounting an electrical conductor according to the present invention e.g. in an electrical cabinet compared to prior art connectors having the same specifications.

The formulation manufactured in one piece or monolithically connected is in this description used to describe that the geometry or structure of the electrical conductor is formed in one single piece. One way of doing so is by manufacturing the conductor by an additive manufacturing process. Thereby, the conductor is manufactured as a single piece, unit or block from one end to the other or at least one end and a middle segment is manufacture as a single piece. Such conductor may thus be formed from a single material as a single piece, unit or block where its one or more ends are monolithically formed with a middle segment connecting the one or more ends i.e. monolithically formed or formed should be understood as made in one continuous process with no need for additionally adding one part to another I.e. one or more ends are manufactured together with the middle segment as one unit with no connections such as welding, soldering, or by any clamping or fastening means, except for the type of micro binding intrinsic to the particular additive manufacturing technology utilized, such as, e.g., layer-by-layer melting, sintering, liquid binding, spraying, etc. With this said, it should be mentioned, that it is possible to add additional elements such as terminals, cooling fins, etc in a post manufacturing process e.g., by a cold spray process.

In an exemplary embodiment of the invention the at least one of said one or more fastening areas are monolithically connecting:
said first end to said second end, or
said first end to one of said two or more conductor sections, or
said second end to one of said two or more conductor sections, or
said second end to one of said two or more conductor sections.

Accordingly, the fastening area(s) may be part of the electrical conductor and thus part of the current path through the electrical conductor. Hence, an electrical conductor may according to the invention comprise more than one conductor section and one or more fastening areas formed in/as one piece/conductor with no physical connection of parts needed.

The conductor may be fastened to the support structure by a bracket clamping around the conductor at a fastening area where the bracket is mechanically connected to the support structure. Hence, a fastening area may not be different from a conductor section other than the fastening area is determined for being the location of the conductor at which the conductor is fastened to the support structure.

In an exemplary embodiment of the invention the at least one of said one or more fastening areas comprising a mounting piece configured to connect said electrical conductor to said support structure.

A mounting piece is advantageous in that it may be a predetermined location of the conductor configured for establishing a physical connection of the conductor to a support structure.

Preferably the mounting piece, when used to connect the conductor to the support structure, is galvanic isolated from the support structure. Hence, either at the mounting piece, the bolts or bands that are used for fastening or the part of the support structure to which the mounting piece is mechanically fastened are used as insulation.

In an exemplary embodiment of the invention the mounting piece is selected from the list comprising: mounting point, mounting recess, mounting hole.

A mounting recess may be advantageous if the fastening of the conductor to the support structure is made by a band in that the recess may be adapted to the width of the band and thus secure fixation of the band at a precise location of the conductor.

A mounting hole may be advantageous if the fastening of the conductor to the support structure is made by bolts/nuts.

In an exemplary embodiment of the invention the at least one of said one or more fastening areas is monolithically connected to said mounting point.

A mounting point monolithically formed as part of the electrical conductor may be advantageous in it that may be designed as a continuous outgrowth i.e. with or without “sharp” (close to 90 degrees) corners and without paying attention to any bending ratio. A drawback of conventional conductors such as busbars is that their bending ration increases dimensions more specific with thickness along the defection axis. Manufacturing the conductor by additive manufacturing, there are no bending needed and thus no bending ratio to comply with.

In an exemplary embodiment of the invention a first mounting point has a first angle to the longitudinal axis of said conductor and wherein a second mounting point has a second angle to said longitudinal axis.

This is advantageous in that in some electric system, this may reduce the required footprint of the conductor.

In an exemplary embodiment of the invention the support structure is an electrical cabinet.

In an exemplary embodiment of the invention the electrical conductor comprises a plurality of thermal banks distributed between said first end and said second end.

This is advantageous in that it has the effect, that heat can be absorbed by said electrical conductor via the thermal banks thereby prolonging the time an electrical conductor is able to carry a high current.

Thermal banks may be implemented as a local outgrowth of a size required to absorb the desired energy in form of heat, as an additional layer of material along added to or to part of a conductor section, etc.

In an exemplary embodiment of the invention the electrical conductor comprises a conductor section part or part of a conductor section without a thermal bank.

This is advantageous in that it has the effect, that in case of a shot circuit the current running in the electrical conductor may melt or in another way cut the electrical conductor and thereby assist a circuit breaker in stopping the current from running in the electrical conductor at a predetermined location.

It should be mentioned that the distribution of the thermal banks may even over the length of the electrical conductor or over part of the electrical conductor. If one thermal bank is not implemented, it is likely that it is between the two neighbouring thermal banks of the missing thermal bank that the conductor will break.

In an exemplary embodiment of the invention the distance between two of said two or more conductor sections is below 15 cm, preferably below 10 cm, most preferably below 5 cm.

This is advantageous in that it has the effect that it adds a layer of security to the electric system. Typically, a circuit breaker is protecting the electrical conductor and components connected thereto, but by designing one of the conductor sections to melt e.g. at 59 ka this acts together with the circuit breaker and thereby increases safety of the system i.e. mitigates the risk of a component is damaged as result of a shot circuit.

In an aspect, the invention relates to a high-power electrical system comprising two or more independent electrical conductor, wherein at least one of said two or more independent electrical conductors is a first independent electrical conductor. Wherein said first independent electrical conductor comprising a first end and a second end and is configured for being fastened to a support structure at one or more fastening areas, wherein said one or more fastening areas separate said first independent electrical conductor in two or more conductor sections. Wherein a first conductor section of said two or more conductor sections of said first independent electrical conductor has a first area moment of inertia with respect to a reference axis, and wherein said electrical system is characterized in that a second conductor section of said two or more conductor sections of said first independent electrical conductor has a second area moment of inertia with respect to said reference axis, which is different from said first area moment of inertia.

Such electrical system is advantageous in that by designing at least one of the two or more independent electrical conductors with different area moment of inertia, and thus capable of resisting different forces acting at different locations along the electrical conductor, a higher flexibility in routing of the two or more independent electrical conductors in the system is obtained. This is e.g. because the distance between the two or more independent electrical conductors may vary while ensuring the area moment of inertia of the conductors is sufficient to resist forces between the two conductors e.g. caused by a short circuit in the electric system.

It should be mentioned that a second independent electrical conductor and/or a third independent electrical conductor may comprise similar conductor sections defined in as described above with reference to the first independent electrical conductor. Hence, a three phased electrical system may be provided with one or more electrical conductors each having conductor section with different area moment of inertia. Such electrical system is advantageous in that it has the effect, that since the area moment of inertia can be determined between conductor sections, a conductor section can be predetermined to heat more up that other, vibrate more than other, deflect more than other, melt more than other, etc. during a short circuit event in the electrical system.

It should be noted that one of the three conductors may be the support structure in the form of the electrically conductive material of an electrical cabinet.

Hence, a short circuit may occur between a conductor and the electrical cabinet and thereby ground in that in most electrical systems the electrical cabinet is grounded.

In an exemplary embodiment of the invention the conductor section of said first independent electrical conductor has a geometry establishing an area moment of inertia optimized to stabilize said first independent electrical conductor from a force acting in a first direction, and wherein a conductor section of a second independent electrical conductor has a geometry establishing an area moment of inertia optimized to stabilize said second independent electrical conductor from a force acting in a second direction, wherein said first direction is opposite said second direction.

An example of optimizing area moment of inertia optimized to stabilize the conductor could be to provide a fin e.g. in the longitudinal direction of conductor section and thereby distribute the forces acting on the conductors section via the fin.

In an exemplary embodiment of the invention a first conductor section of said first independent electrical conductor s spaced from a second independent electrical conductor with a first distance, wherein a second conductor section of said first independent electrical conductor is spaced from said second independent electrical conductor with a second distance, wherein said first distance is different from said second distance.

Although here only the second independent electrical conductor is mentioned, distances between the first and third and between the second and third independent conductors may also be determined and be different as described with respect to the first and second independent conductors.

This is advantageous in that it has the effect, that the material needed for the part of the two conductors having the second distance is reduced compared to the material needed for the part of the two conductors having the first distance.

In an exemplary embodiment of the invention the distance is measured at the middle of a conductor section in an angle perpendicular (Y or Z) to the longitudinal axis (X) of said independent electrical conductor.

Typically, the direction perpendicular to the longitudinal axis of the conductor is a transversal direction and thus may be perpendicular to the current path through the conductor at the point of measuring. As the conductor may not have a uniform geometry, the distance may be measured from the periphery of the conductor in a direction perpendicular to the longitudinal axis/current part of the second or third conductor.

In an exemplary embodiment of the invention the difference between first and second distance is more than 1 mm, preferably at least 0.5 cm, most preferably at least 1 cm.

This is advantageous in that an airgap exists having the size of the distance between two conductors and thus acts as an isolator therebetween. Hence, to avoid arc flashovers at high voltages e.g. in moist air a distance above 1 cm such as above 2 cm should at least be between two conductors. The maximum distance is typically given by the footprint of the cabinet comprising the electrical system but is in general desired to be as large as possible in that then material used for the conductor can be reduced. This is because the forces between two conductors is reduced as the distance therebetween is increased leading to a reduction of required area moment of inertia.

A high-power electrical system according to any of the claims 41-45, comprising an electrical conductor according to any of the claims 1-40.

In an aspect, the invention relates to a method of designing a first electrical conductor of a high-power electrical system according to its physical location in said high-power electrical system relative to a second electrical conductor, said method comprising the steps of:
establishing minimum physical distance between said first and second electrical conductors, and defining an area around the location of said first electrical conductors at said minimum physical distance as a minimum conductor section,
establishing a force occurring from at least one short circuit current at said minimum conductor section,
establishing a bending moment of said minimum conductor section of said first electrical conductor provided by said force,
establishing an area moment of inertia with respect to a reference axis of said minimum conductor section based on said bending moment and based on a maximum allowed stress of said minimum conductor section, and
establishing a required length and height of said minimum conductor section based on said area moment of inertia.

In an exemplary embodiment of the invention the required length and height of said minimum conductor section is different from a length and height of a from an additional conductor section of said electrical conductor.

In an exemplary embodiment of the invention the maximum allowed stress is the yield point of a material of which said electrical conductor is made.

Such method of designing an electric conductor is advantageous in that it has the effect that by designing the electrical conductor according to area moment of inertia required to withstand a force from a short circuit current at a given conductor section, a reduction of material of the conductor can often be obtained at other conductor section. Further, it is possible to design a conductor with only the necessary number of mounting points for securing the conductor to the support structure leading to a faster mounting and reduction of components used to securing the conductor.

The moment of inertia to withstand the force from the short circuit should be high enough to ensure that no damage is done to the conductor. Damage should here be understood as when the current has been stopped, the conductor does not have any cracks or missing parts. Put in another way, the area moment of inertia should be determined based on the yield point of the material of the conductor. In this way, the area moment of inertia is determined exactly as high i.e. exactly with the needed material to withstand forces created from short circuit currents.

It should be noted that the maximum allowed stress may alternatively be determined by allowable level of stress related e.g. to a desired safety factor or the like.

In an exemplary embodiment of the invention the at least one short circuit current is the worst-case short circuit current for the conductor, wherein the worst-case short circuit current is determined based on the following input: current in said first and/or second electrical conductor, shortest distance between said first and said second electrical conductor and distance between two mounting points mounting said first electrical conductor to a support structure.

Based on these inputs, the worst-case short circuit current can be calculated and thus the force with which one conductor is impacting the other. Hence, if the geometry of the first electrical conductor is fixed an adjustment of the distance between mounting points can be made or additional mounting points may be included.

In an exemplary embodiment of the invention the area moment of inertia required to withstand said force is determined from the distance from middle point between two mounting points to one of these mounting points multiplied by said force.

In an exemplary embodiment of the invention a user designing said first electrical conductor by use of s computer program is able to add fastening areas, mounting points or support structure, at user defined areas of said first electrical conductor.

Alternatively, location of such fastening areas, mounting points or support structure are suggested by the computer program.

A method according to any of the claims 47-52, comprising an electrical conductor according to any of the claims 1-40.

A method according to any of the claims 47-53, implemented in a high-power electrical system according to any of the claims 41-46.

### THE DRAWINGS

For a more complete understanding of this disclosure, reference is now made to the following brief description, taken in connection with the accompanying drawings and detailed description, wherein like reference numerals represent like parts. The drawings illustrate embodiment of the invention and elements of different drawings can be combined within the scope of the invention:

FIG. 1a-1e illustrates an electrical conductor, moment of inertia and forces related to the electrical conductor,

FIG. 1g-1h illustrates an electrical conductor having a transition section,

FIG. 2 illustrates three electrical conductors in a three phased high-power electrical system,

FIG. 3a illustrates an electrical conductor comprising a conductor support structure,

FIG. 3b illustrates an electrical conductor comprising conductor branches and conductor support structure,

FIG. 4 illustrates an electrical conductor with different mounting points,

FIG. 5 illustrates an electrical conductor having a transition conductor section,

FIG. 6 illustrates two electrical conductors having varying distances therebetween,

FIG. 7 illustrates two electrical conductors having different mass,

FIG. 8a-8b illustrates an electrical conductor having varying geometry and material thickness with same cross-sectional area,

FIG. 9 illustrates an electrical conductor having thermal banks,

FIG. 10 illustrates a system according to the invention, and

FIG. 11 illustrates a flow chart of a method of manufacturing an electrical conductor according to the invention.

### DETAILED DESCRIPTION

The present invention is described in view of exemplary embodiments only intended to illustrate the principles and implementation of the present invention. The skilled person will be able to provide several embodiments within the scope of the claims.

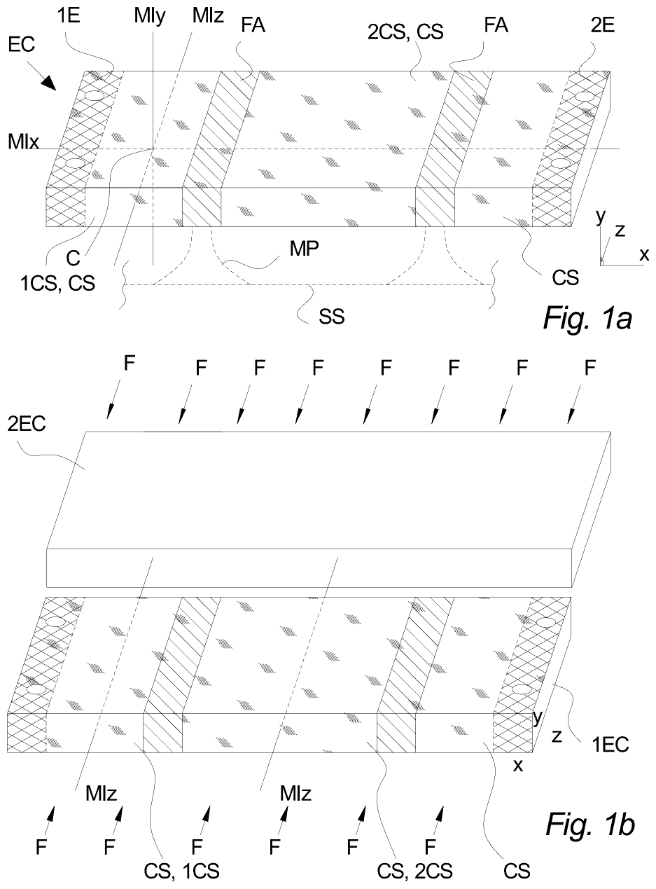

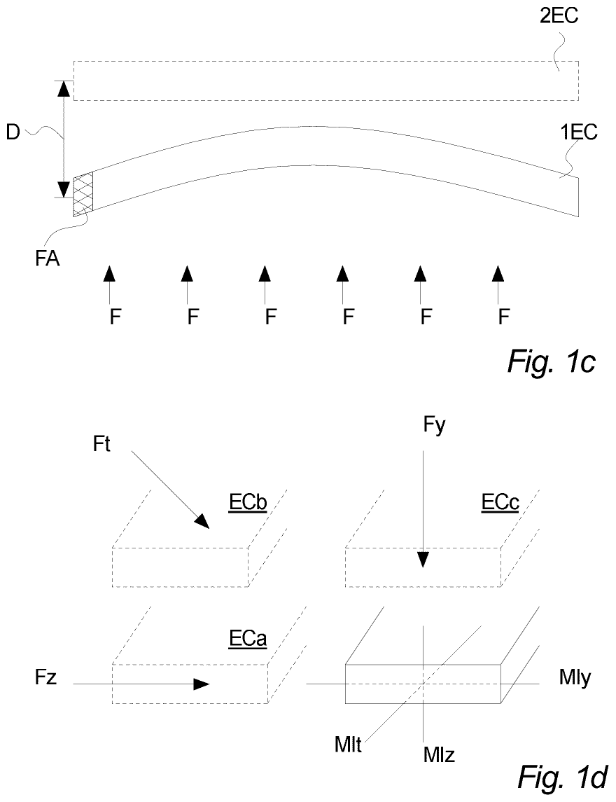

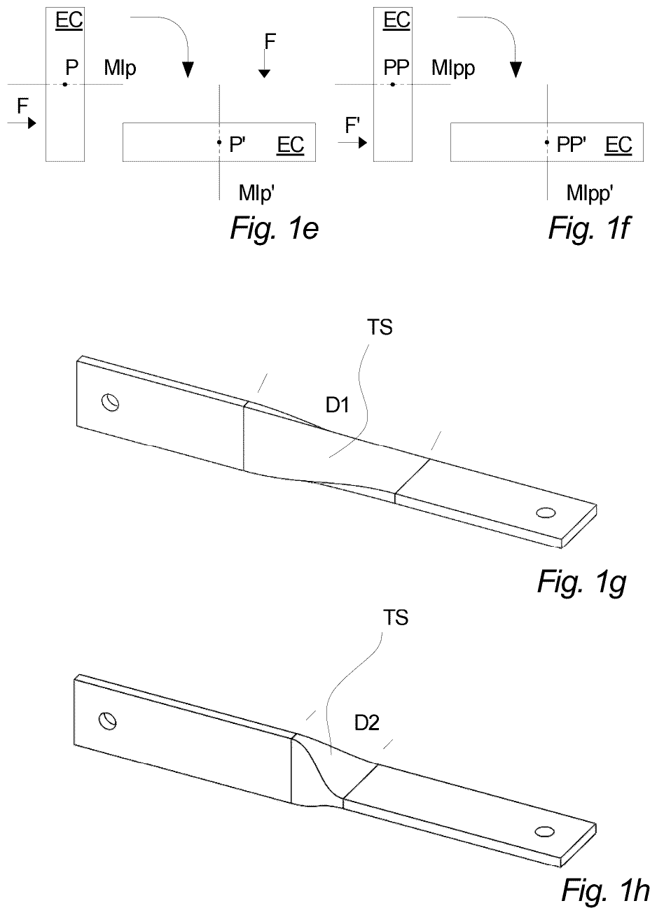

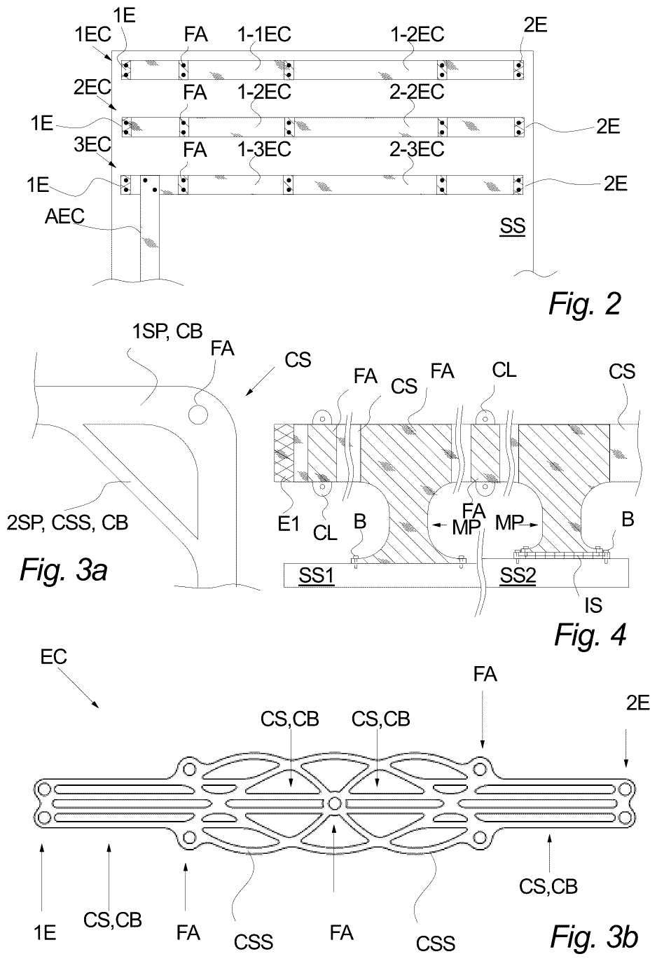

The electrical conductor EC illustrated in FIG. 1a comprises first and second ends 1E, 2E and two fastening areas FA. Thereby, the electrical conductor EC comprises three conductor sections CS of which one, between the first end 1E and a fastening area FA, is referred to as first conductor section 1CS and one, between the two fastening areas FA, is referred to as second conductor section 2CS.

The area moment of inertia MI of a conductor section CS of the electrical conductor EC illustrated in FIG. 1a may be established with reference to any orientation in space. FIG. 1a illustrates three such orientations in the form of reference axis for the calculation of area moment of inertia namely those that are referred to as the heigh (MIy), width (MIz) and length (MIx).

The area moment of inertia of a conductor section is dependent on its geometry (such as its dimensions, etc.). For a conductor section CS having a standard rectangular cross-sectional area, the area moment of inertia can be calculated from the following equation 1:

$$MI = \frac{1}{12} * b * {h}^{3} \qquad EQ1$$

where b is the length of the side of the cross-section that is perpendicular to the direction of the force and h is the length of the cross-section that is parallel to the direction of the force. Note that the area moment of inertia MI calculated by equation 1 is calculated with respect to a center axis for a symmetric rectangular cross-section.

The area moment of inertia of the conductor section must be sufficient to withstand forces acting on the conductor section. Such forces may occur from gravity (the weight of the conductor itself and any conductors or components connected thereto), from vibrations of the conductor (from an acceleration that may be introduce a G-force to the weight of the conductor, the g-force is multiplied to the weight of the conductor) or from an electromagnetic force created by a short circuit current conducted by a neighbouring electrical conductor EC, etc. In a short circuit situation such current may be extremely high such as between 2 kA and 300 kA.

Withstand should be understood as being able to continue operation after having been exposed to a force e.g. created from a short circuit i.e. the conductor section should not break or deform plastically such as e.g. cracking or disintegrating when exposed to such force. Accordingly, the conductor section should be designed with material properties ensuring that stress of the material provided from such force introduce, is less than a predetermined level such as less than the yield point of the material of the conductor section, to ensure that any deformation of the conductor section is not plastic deformation.

According to the present invention, typically it is only relevant to determine the material stress from a force occurring from one direction namely from the direction in which a neighbouring electrical conductor is located. This is because the highest or worst-case force the two neighbouring conductors must be able to withstand is the force from the created electromagnetic field occurring in case of a short circuit involving at least one of the conductors. As this force is dependent on distance between the two neighbouring conductors the highest force between the two is determined where the distance therebetween is shortest. Thus, the conductor section design is preferably optimized to ensure that it can withstand a force F from a conductor section of a second conductor where the distance between the respective reference axis is shortest.

An electromagnetic force F from such short circuit is possible to calculate based on size of short circuit current and distance between the conductors. Then, it is possible to calculate the bending moment M a conductor is exposed to from this electromagnetic force F. From the conductor material the yield point is known and thus the level of stress the chosen material can handle before plastic deformation occur. From this information, it is possible to calculate the area moment of inertia MI necessary for a conductor to withstand the calculated electromagnetic force F. From this, it is possible to determine the combination of high y and width z where a distance Y from center/neutral axis of the cross-sectional area of the conductor section to the outer edge of the cross-sectional area is the maximum high.

Accordingly, from the force F, it is possible to calculate the necessary area moment of inertia MI from the material property Yield Point σ together with the bending moment M. From the area moment of inertia MI it is possible to derive e.g. width and height or more complex geometry of the conductor. These steps of dimensioning a conductor or a section of the conductor will be described in further details below. The term conductor is used while understanding that it may only be a conductor section that is subject to the calculations.

Accordingly, based on these inputs, it is possible to design the conductor with an area moment of inertia MI ensuring that stress impact from the bending moment M/force F is below the yield point of the conductor. Thus, in this way it is possible to use area moment of inertia MI as a design parameter when designing a conductor and thereby design the conductor to match the required yield point to avoid plastic deformation, cracks, disintegration, etc. In this way a reduction of amount of material used for the conductor is possible to obtain compared to traditional way of designing electrical conductors.

FIG. 1b illustrates an example of a first and second electrical conductor 1EC, 2EC located parallel to each other where the first electrical conductor 1EC is the one illustrated on FIG. 1a. Only the contours of the second electrical conductor 2EC is illustrated with stipulated lines. It may be similar to the first electrical conductor 1EC i.e. with respect to geometry and fastening to support structure or it may have alternative geometries.

As the two electrical conductors 1EC, 2EC is located next to each other in the Z plan, the highest (worst-case) force F one conductor would impact the other with, in case of a short circuit, would be in this plan as indicated by the arrows denoted F. The worst-case force F occurring from the created electromagnetic fields e.g. following a short circuit is calculated as a function of the size of the short circuit current and the distance between the two conductors 1EC, 2EC.

With this said, in case of a short circuit, the size of this force F is determined by the electromagnetic field created by the short circuit current. The impact (bending moment M) of this force F on the neighbouring conductor is predominantly determined by the distance between reference axis of the two conductors. A reference axis of the conductor may be any bending axis such as an axis going through the centroid of the conductor and an area moment of inertia may be calculated relative to such reference axis. Hence, the bending moment M caused by this force is mainly determined by the size of the short circuit current and the distance between the reference axis of the two conductors. With this said, the geometry of a conductor may also have impact on its resistance to bending. Accordingly, a change in geometry may lead to a change in area moment of inertia MI, but a change in geometry may also be made so that two geometries have the same area moment of inertia.

If the electric system in which the two conductors are used is an AC system having in-phase currents, the force F will alternatingly push and pull the neighbouring conductor following the sinusoidal waveform of the AC short circuit current. This is because the operation sign of the current change leading to a change in the electromagnetic field and thus in the force F. If the currents are out of phase, the force F may partly or completely cancel one another.

Hence, in a three phased system the direction of the current and thus of the electromagnetic field is so that in a first phase current is running in one direction, in a second phase current is running in the opposite direction and in the third phase the current is running either in the first or in the second direction. Accordingly, in the two conductors where the current is running the same way, a force therebetween will attract (pull) or repel (push) the two conductors. The conductor where current is running opposite direction will repel (push) from the other. Hence, the electromagnetic field is changing with polarity of the current and thus is not stationary over time. In a short circuit the current will increase over time and thus create an increasing electromagnetic filed around the conductor. Therefore, the force created by this field is also increasing. It should however be noted that the force F is created when the electromagnetic field is interacting with another magnetic field or magnetic material such as an electrical field created by a current conducted by a neighbouring conductor. Based on this knowledge, it is possible to design the geometry of the conductor according to the direction of this force, which may lead to a conductor, or section hereof, having the most mass as far away from the reference axis as possible. The reference axis and the direction of the force F may be in the same plane or in parallel planes.

In case of a DC system, the force F would be a push or pull from one conductor to the neighbouring conductor. With this said transients typically occur as consequence of a short circuit, which may impact the direction of the electromagnetic field and thereby the direction of the force. The direction of the force relative to the electromagnetic field can be determined by the right-hand rule.

In the situation where three or more electrical conductors are considered the force provided by a short circuit current is the force from the resulting current. Hence, the short circuit current and thus the force provided therefrom is depending on type of short circuit (two, three phased, to neutral/ground, etc.) i.e. the force is a resulting force from two or more contributors and thus more complex to determine. Accordingly, the required area moment of inertia of the different conductors in such situation may be the same. As an example, in a system having three parallel conductors in the same plane and with the same geometry, the middle conductor may need to have a geometry with a higher area moment of inertia to be able to withstand forces from two neighbouring conductors i.e. a higher force than the two neighbouring conductors (one force may pull an done may push in the same direction). The other conductors may not need as high an area moment of inertia because the force they may be exposed to, is from one direction and since the force from the conductor located most remote is reduced with distance. Accordingly, the geometry of the middle conductor may be different from the geometry of the conductors at the sides due to the different requirements to area of inertia.

In general, the short circuit current is possible to determine when designing the electrical system. In fact, often dimensions of electrical conductors (geometry, amount of material used in length, width and height, etc.) in an electrical system is designed based on short circuit calculations. Hence, the short circuit current calculation is more or less standard calculations which is based on wherein the electric system the short circuit occurs, if the electric system is a 1 or three phased system, etc. Such calculations are known by a person skilled in art or can easily be found from a search on the Internet.

Once the short circuit current is determined, the electromagnetic force created by this current, referred to as the force F, on a bus bar of two neighbouring busbars, such as those illustrated in FIG. 1a, 1b, 1c and 1d, can be calculated based on the formular of equation 2:

$$F = K \frac{{I}^{2}}{S} \qquad EQ2$$

Where: F is force on the current carrying conductor, I is the short-circuit current (assuming it is the same in both conductors) and S is the space between reference axis or center lines of the conductors. The constant K is a correction factor that is determined e.g. by the electromagnetic permeability of air, geometry of the conductor, a mathematical constant, configuration of conductors such as number of conductors and there interrelated location, mounting points, etc. This formular may also be known by the skilled person or found by a search on the Internet.

As mentioned, the force F acting on the conductor is causing a bending moment M. The relationship between this force F and the bending moment M is MI=F*X.

The bending moment M introduce a stress in the conductor and to ensure that it is possible to continue operating an electrical system, within which the conductor is conducting a current without maintaining or replacing the conductor subsequently, the conductor need to be able to withstand this stress. Hence, the stress introduced by the bending moment need to be below the yield point of the material of the conductor. Thus, as the relationship between the allowed stress (yield point) and areas moment of inertia MI is as follows in equation 3, the required area moment of inertia MI of the conductor can be calculated from equation 3:

$$σ = y * \frac{M}{MI} \qquad EQ3$$

where σ is allowed stress (conductor material yield point), M is bending moment, y is distance from center/neutral axis of the cross-sectional area of the conductor section to the outer edge of the cross-sectional area and MI is the area moment of inertia.

Based on the calculated area moment of inertia MI, it is possible to derive design parameters such as width and height for the conductor according to the above-mentioned equation 1 which is inserted again:

$$MI = \frac{1}{12} * width * {height}^{3}$$

With reference to FIG. 1b where the width is denoted z and height is denoted y and where the force F being parallel to the height Z, equation 1 looks like this:

$$MI = \frac{1}{12} * y * {z}^{3}$$

Accordingly, now it is possible to insert different values for z and y and thereby design the conductor so that it is able to withstand the stress originating from the short circuit current.

With the determined dimensions of the conductor it is now possible to check if the conductor with these dimensions is possible to implement in the available physical space e.g. inside an electric cabinet with respect to deflection of the individual conductor. For an evenly distributed force on a simple support conductor section, this may be done by equation 4

$${U}_{x} = \frac{f * {l}^{3} * x}{24 * E * MI} ( 1 - 2 {( \frac{x}{l} )}^{2} + {( \frac{x}{l} )}^{3} ) \qquad EQ4$$

Where U is the deflection, x is the distance from an end of the conductor where the deflection is calculated, f is the force, l is the length between two mounting points, E is Youngs Modulus for the conductor material and MI is the area moment of inertia.

The electromagnetic field from a short circuit current is created 360 degrees around the conductor, but according to the present invention. However, the electromagnetic force F is only created when two magnetic fields or one magnetic field and a magnetic material such as steel are interacting.

It should be remembered that the area moment of inertia is related to geometry and independent of the force F. The force F occur as consequence of the electromagnetic fields between two conductor and the force impacts both conductors. The present invention relates to designing a conductor according to the considerations of electromagnetic force F occurring from a short circuit current. This may include designing conductor fastening areas/mounting points to a support structure.

The mounting points may be rigidly fixed to the conductor which may be advantageous if it is desired to reduced bending of a conductor section between two fastening points. Rigidly fixed mounting points may be connected to a support structure via an isolating material galvanic isolating the mounting point from the support structure. Alternatively, the conductor may be connected to the mounting point via a flexible connection. This may be advantageous if it is desired to allow rotation of the conductor around a bending axis and thereby e.g. absorb production variations.

FIG. 1c, illustrates the conductors of FIG. 1b where the force F is acting on the first conductor 1EC creating a bending moment causing the conductor 1EC to bend towards the second conductor 2EC.

It should be noted that a conductor section in general comprise at least one end that is fixed as illustrated in FIG. 1a. This end may be any of the two ends of a conductor section of which an area moment of inertia is calculated. Thus, a conductor section may be part of a conductor between two fastening areas/two ends/one end and one fastening area of which one or more fastening areas are fixing the conductor section to a support.

It should be mentioned that most of the above-mentioned equations are simplified and may not be fully correct in all situations. More specific if it is not possible to determine a width (b) and height (h) of a cross-sectional area of a conductor section, the above-mentioned equations may not apply as presented. In this case, assistance from computer programs may be needed to calculate the different values.

At least with respect to short circuit currents but also with respect to moments and forces further and more detailed calculations may be found in the DS/EN60865-1 2. Udgave 2012 Apr. 20, Danish standard titled: Kortslutningsstrømme Beregninger af virkninger—Del 1: Definitioner og beregningsmetoder which is hereby incorporated by reference.

When looking in the cited standard DS/EN60865-1, it is noted that calculation is made with respect to standard geometries (such as circular and rectangular). No hints are found regarding calculations on varying geometries as the conductor sections CS of the present invention.

As an example, it may be required that the first conductor 1EC is fixed to a support structure SS at the fastening point FA in the first end 1E and the second end 2E is not fixed to a support structure. Further, at large bendings such as bendings leading to plastic deformation, the equations may not be accurate. Further, transversal forces may contribute together with the area moment of inertia to inertial stress level of the conductor and thus may be determining for the dimensions of the conductor. Accordingly, a more accurate calculation transversal forces leading to transversal stresses σ may be made by equation 5:

$${σ}_{v}^{2} = \frac{1}{2} [ {( {σ}_{11} - {σ}_{22} )}^{2} + {( {σ}_{22} - {σ}_{33} )}^{2} + {( {σ}_{33} - {σ}_{11} )}^{2} + 6 ( σ + {σ}_{31}^{2} + {σ}_{12}^{2} ) ] \qquad EQ5$$

Where σ is stress in the directions (denoted 11, 22, 33, 23, 31 and 12) introduced in the equation.

FIG. 1d illustrates a few examples of locations of neighbouring electric conductors ECa-ECc to a first electrical conductor 1EC. The electrical conductors EC are illustrated in an end view and similar illustrations could be made in a side view as indicated in FIGS. 1a and 1b. FIG. 1d also illustrate reference axis Miz, Mit, Miy with respect to which the relevant area moment of inertia MI may be calculated. The relevant area moment of inertia MI is with respect to which of the forces Fz, Ft, Fy acting between the conductors in case of a short circuit.

It should be mentioned that in most cases an electrical conductor according to the present invention is comprised by a three phased electrical system. In such system, the three phased current is conducted by three individual conductors which may be implemented as cables or busbars. Such three conductors may be identical and parallel at least part of the way through the electric system. However, as this is not always possible e.g. due to other electrical conductors or components of the electric system, parts of the conductors are changing locations relative to each other. In this situation, it is advantageous to adjust the area moment of inertia of part of the conductor because, as mentioned above, the force F from a short circuit current will not be the same at the parallel and the changed part.

The area moment of inertia MI is relatively easy to establish in some of the configurations and relatively complex in other configurations. With reference to FIG. 1d, the area moment of inertia referred to as Miy and Miz are relatively easy to establish whereas areas moment of inertia referred to as Mit is a bit more complex due the angled location of the conductors. Further, if the geometry is not simple bar-like as illustrated the calculations are even more complex and would typically be made by a computer program. Further, if the electric system includes three or more electric conductors, the calculations may also be a more complex than if only two conductors are included in the calculations.

It should be noted that preferably also the neighbouring conductor EC can expect to be exposed to the same nominal force in case of a short circuit and therefore advantageously may have the same area moment of inertia as the conductor 1EC. Note that even if the area moment of inertia is the same, the geometry does not need to be the same.

With respect to area of moment of inertia, it is preferred that two neighbouring conductors are placed next to each other as 1EC and ECa on FIG. 1d. In this way the force F is acting on the conductor in the direction where the conductor has the most mass the farthest away from the reference axis i.e. from the MIz axis (Mz<My) of FIG. 1d. In this way, the force is easiest absorbed by the conductor.

As mentioned above if two conductors have relatively simple conductor geometry and mutual location the area moment of inertia is relatively easy to determine. However, when angles are introduced or non-regular geometry of the conductors, the establishing of the area moment of inertia becomes more complex and thus typically established by assistance from a computer program such as Ansys, nTop, Solidworks, etc. This is also true if it is considered relevant to include contributions of force e.g. from additional conductors or other conductor sections which the area moment of inertia of a conductor section should be able to withstand.

As mentioned, the area moment of inertia MI of a conductor section CS of the electrical conductor EC may be established with reference to any orientation in space/reference axis going through the centroid of the conductor. FIG. 1a illustrates three such axis namely those that are referred to as the heigh (MIy), width (MIz) and length (MIx).

Accordingly, if both the conductor EC and the force F acting on the conductor is rotated e.g. 90 degrees as illustrated in FIG. 1e, area moment of inertia at a particular point P of an axis MIp of the electrical conductor EC is maintained the same i.e. MIp and MIp′ are the same. In this example, the resistance of the electrical conductor EC to withstand a force F acting on the electrical conductor EC from this new angle is maintained.

However, if a force F′ acting on the electrical conductor EC is not rotated with the conductor EC as is the case in FIG. 1e i.e. is continuing to act from the same direction. Then, the bending moment M acting on the conductor EC is different. More specific the bending moment acting on conductor to which the force F′ acts perpendicular to the MIpp axis is higher than the bending moment M on the conductor to which the force F′ acts parallel to the MIpp′ axis. Thus, the area moment of inertia MIpp required to withstand the force F′ is different from the area moment of inertia MIpp′ i.e. MIpp is not equal to MIpp′ (more specific MIpp>MIpp′).

At FIGS. 1e and 1f, cross-sections of an electrical conductor EC are illustrated. FIG. 1g illustrates an example of an electrical conductor having two conductor sections 1CS, 2CS having the same cross-section but twisted/rotated 90 degrees relative to each other. Accordingly, if the electrical conductor illustrated in FIG. 1g have the same geometry and dimensions, the points P, PP, P′, PP′ referred to from FIGS. 1e and 1f could be points on opposite sides of a twist of the conductor as illustrated.

Accordingly, the geometry is preferably designed to have the desired area moment of inertia with reference to a force acting from a certain direction. One way of doing so is to increase the material spread from the bending axis which is also referred to as the reference axis for calculating the area moment of inertia. The more material the further away from this axis the stiffer the conductor tends to be and thus the better the conductor is to resist bending caused by the electromagnetic force F.

Accordingly, the area moment of inertia (also sometimes referred to as the second moment of area) can be said to be a measure of a cross-section resistance to being and is depending on the shape of the cross-section. An example of a cross-section having a high resistance to being is an I-beam. Thus, a varying cross-section may lead to a varying area moment of inertia.

According to the present invention the, the conductor may be manufactured by additive manufacturing and thus e.g. 3D printed in a desired geometry. Hence, the conductor illustrated in FIG. 1g may suffer from deformations and minor cracks along the sides (width) of the twisted part of the conductor. These drawbacks can be minimized if the transition section is made longer and at least it requires some length to ensure not crossing the yield point of the conductor material. The conductor illustrated in FIG. 1h is manufactured with a transitions section TS avoiding the drawbacks of the known twisted conductor. The transition section TS may in fact act as a thermal bank in that more material is used in this section compared to the transition section TS of a known twisted conductor. It should however be noted that the transition section of FIG. 1h is only one possible way of designing the transition from one orientation of the conductor to another.

Further, the transition section TS of the conductor illustrated in FIG. 1h is shorter than the transition section TS of the conductor illustrated in FIG. 1g. Thereby it is possible to position components such as power modules of a converter closer together and thereby reduce the size of the converter footprint.

As mentioned, three electrical conductors 1EC, 2EC, 3EC of the present invention may be used together to distribute current in a three phased high-power electric system. The illustrated support system SS may be implemented as an electric cabinet which may enclose the electric conductors EC. The three electric conductors may be supplied with power from non-illustrated cables from outside of the electric cabinet. Such supply may e.g. be from a utility grid or a renewable energy generator. The three conductors may distribute current to components of the electric cabinet e.g. via auxiliary electric conductors AEC of which only on is illustrated.

The three illustrated electric conductors may be similar in geometry and frequency of fastening areas dividing the conductors in first conductor sections 1-xEC and second conductor sections 2-xEC. Thus, they may have the same area moment of inertia MI. With this said, in case of a short circuit, the middle conductor 2EC may be exposed to a force F from both the first and second conductors 1EC, 3EC. Therefore, the middle conductor may, contrary to what is illustrated, have a higher frequency of fastening areas FA or have a higher area moment of inertia MI.

FIG. 3a illustrates a non-limiting example of a conductor section CS having a first section part 1SP and a second section part 2SP of different cross-sectional areas and thus of different area moment of inertia. The conductor support structure CSS (second section part 2SP or conductor branch CB) may be monolithic formed from the conductor section CS and may also conduct a current. The conductor support structure CSS may increase structural stability of the conductor section CS and due to a higher area moment of inertia of this particular conductor section CS.

The first support part 1SP is illustrated to comprise a fastening area in the form of a hole through the conductor. Such fastening point together with the conductor support structure may enable an even higher area moment of inertia.

In this example, within the conductor section, two conductor branches may gave a varying area moment of inertia.

Another alternative electric conductor EC according to the present invention is illustrated in FIG. 3b. This conductor comprises three fastening areas FA and a first and second ends 1E, 2E separating the conductor in four conductor sections CS. The fastening areas are illustrated as holes via which bolts may fix the conductor to a support structure.

The conductor support structure CSS may also be referred to or used as conductor branches CB having the dual purpose of increasing the area moment of inertia and conduct current.

The conductors illustrated in FIGS. 3a and 3b are only examples of how a conductor can have conductor sections CS with varying area moment of inertia established by varying the geometry of the conductor. Other non-illustrated examples may be electric conductors having conductor sections in a bionic design, in a lattice design, with twisted conductor branches, etc. just to mention a few.

A positive side effect of some of these different geometries including those illustrated on FIGS. 3a and 3b is that the possibility of cooling the conductors is increased. This is because a flow of cooling air is able to pass through the different conductor branches.

FIG. 4 illustrates two alternatives to the hole illustrated in FIG. 3a which can be used to fastening the conductor to a support structure SS1, SS2. Two of the fastening areas FA include clamps CL for fastening a fastening area FA to a support structure. The clamps CL are intended for fastening to a non-illustrated support structure e.g. via clips, bolt or screws. Another two fastening areas FA includes mounting legs or points MP. Hence, the mounting points MP are fastening in one direction whereas the clamps are fastening in another direction.

By the additive manufacturing process of the electric conductor, it is straight forward to design it e.g. with monolithic mounting points MP supporting in different directions. Thereby, the conductor may be able to better withstand forces and vibrations acting from different directions.

A first mounting point MP is fastened to a support structure SS1. This support structure is non-conductive in that no isolation is needed between the mounting point and the support structure SS1.

The second mounting point MP is fastened to a support structure SS2 via an isolator IS. Thus, the support structure SS2 may be electrically conductive.

Different ways of fastening the conductor to a support structure may have different impact on the area moment of inertia of a conductor section. The orientation and distance between fastening areas has impact on deflection of the conductor section which can be controlled designing the conductor section with a desired area moment of inertia.

The distance between the two mounting points MP is relevant when bending moment M of the conductor is to be calculated. Looking at a conductor section CS having a mounting point MP in both ends and a distance X between the two mounting point MP. These mounting points each represent half the force F acting on the conductor. In this example, the conductor section is designed so that the highest area moment of inertia MI from the force F is at the midpoint between the mounting points MO. Hence, the bending moment M for a conductor section with a simple support in both ends and with even distribution of force F is determined by equation 6.

$$M ( max ) = \frac{1}{8} * f * {x}^{⋀} 2 . \qquad EQ6$$

As mentioned above, the relationship between to deflection/stress, bending moment M and area moment if inertia MI is

$$σ = \frac{M}{MI} .$$

To avoid plastic deformation of the conductor section, the stress has to be below the material Yield Point. In this way, by varying the distance X between two mounting points it is possible to reduce the required area moment of inertia of a conductor/conductor section.

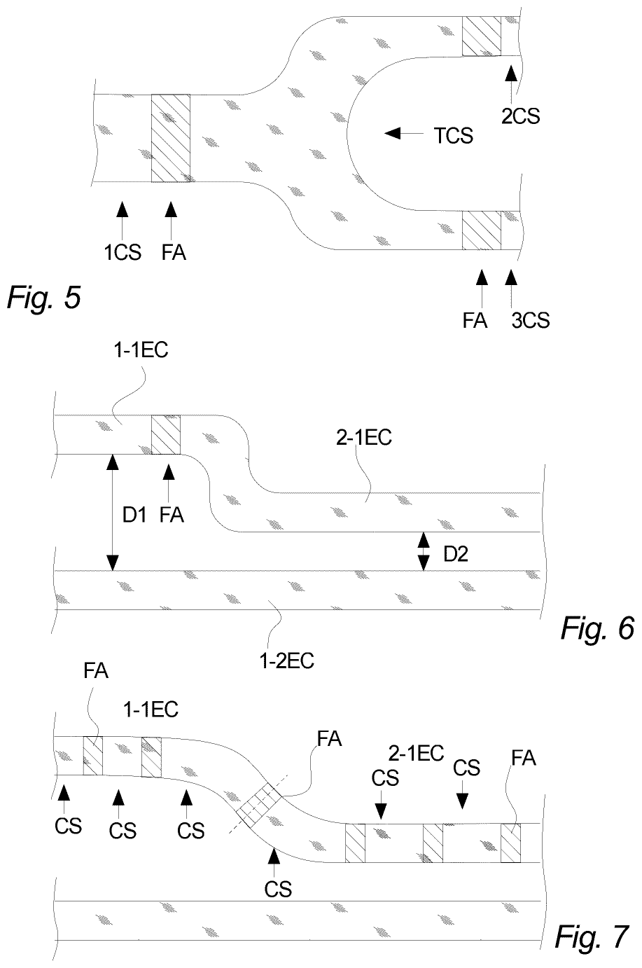

FIG. 5 illustrates part of an electrical conductor having a first conductor section 1CS that is branching off into a second and a third conductor second 2CS, 3CS in a transition conductor section TCS.

Alternative, it could be said that the second and third conductor branches are uniting into one, namely into the first conductor section via the transition conductor section TCS.

As illustrated in FIG. 3b a conductor according to the present invention may have several transition conductor sections TCS for branching off one conductor branch into two or more conductor branches or uniting two or more conductor branches into one conductor branch as exemplified in FIG. 3b.

Obviously, when branching off one larger branch into two minor branches (with respect e.g. to cross-sectional area) the area moment of inertia may change in the two sections. However, it should be noted that it may be possible to design a conductor with several conductor branches that has the same areas moment of inertia as one conductor branch and vice versa.

FIG. 6 illustrates two conductor branches which are parallel. As illustrated, the first conductor section of first electrical conductor 1-1EC is a distance D1 from the first conductor section of second electrical conductor 1-2EC and the second conductor section of first electrical conductor 2-1EC is a distance D2 from the first conductor section of second electrical conductor 1-2EC. As the distance D1 is larger than the distance D2 and because in this example the first and second conductors are supported in the same way and designed to comply with the same maximum deflection, the area moment of inertia has to be larger at the second section of the first conductor 2-1EC compared to the first section 1-1EC.

This may be obtained either by increasing the frequency of mounting points, by increasing the mass of the conductor section or by designing a geometry of the second section 2-1EC so it is optimized to have a high resistant to bending from forces impacting the conductor from the first conductor section of the second conductor 1-2EC.

It should be noted, that in the same way the second conductor may preferably also be divided in two conductor sections even though this is not illustrated. This is because this conductor most likely also would be exposed to a higher force from the second section 2-1EC than from the first section 1-1Ec because the distance D2 is smaller than the distance D1.

In FIG. 7 the area moment of inertia is changed between two conductor sections either by changing the mass of the conductor section which is not easy illustrated in FIG. 7. Alternatively, it is easy to illustrate that the frequency of fastening areas FA is increased. Hence, by reducing the distance between fastening areas FA and thereby the length of the conductor section, the area moment of inertia can be kept constant. The area moment of inertia can also be changed to provide the same deflection with varying support frequency.

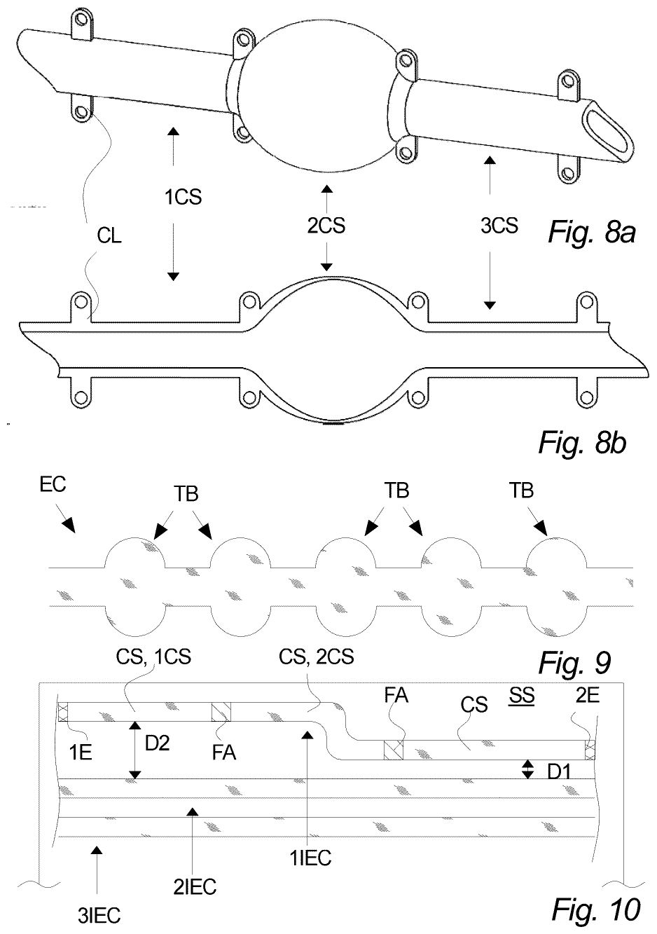

FIG. 8a, 8b illustrates a conductor having three conductor sections 1CS, 2CS, 3CS. The conductor is hollow which may allow a cooling fluid to pass through and thereby increase cooling capacity and thereby the current possible to conduct by the conductor. The conductor sections are established by fastening areas in the form of clamps CL (or wings).

The clamps CL may be intended to fix the conductor to a support structure in two different directions. The clamps CL may be monolithic formed in one with the conductor i.e. a more wing-like design. In the same way, the three conductor sections may be monolithic formed in one piece.

From FIG. 8b, which illustrates a cross-sectional view of the conductor along the longitudinal direction of the conductor, it can be seen, that the cross-section of the conductor is the same even though the geometry changes. This is possible because the material thickness varies in the second conductor section 2CS.

This conductor design is one example of a conductor having conductor sections with varying area moment of inertia where also the geometry is varying.

FIG. 9 illustrates an electrical conductor having thermal banks TB. The thermal banks TB may, contrary to what is illustrated in FIG. 8a, 8b be implemented by increasing the mass at the banks compared to between the banks. The distance between the banks depends on the cross-sectional area of the conductor, the smaller the closer the banks have to be. In a non-limiting example, the distance between two banks is 5 cm.

The purpose of the thermal banks TB is to absorb heat generated by the high short circuit current. And thereby prolong the time a conductor is able to withstand the high current i.e. the time until a circuit breaker is cutting of the current. The temperature increase in a bank is linear with time and power at a given material. Hence, if the mass is doubled, the temperature increase is reduced by half at if the power is constant.

The ability of an electric conductor to absorb heat over a distance via a thermal bank relates to the conductor material properties including specific heat capacity and thermal conductivity. If the conductor comprises ripples, these ripples may cool the conductor by release heat the surroundings via convection. Such ripples may also change the area moment of inertia of the conductor.

FIG. 10 illustrates a system according to the present invention. The system includes three independent electric conductors 1IEC, 2IEC, 3IEC. These conductors may be similar to what is described above relate to electric conductors, fastening areas and conductor sections.

The calculation of electromagnetic force is however more complex in a three phased system as the one illustrated. Considerations relevant for a three phased system is provide above e.g. in relation to the description of FIG. 1b.

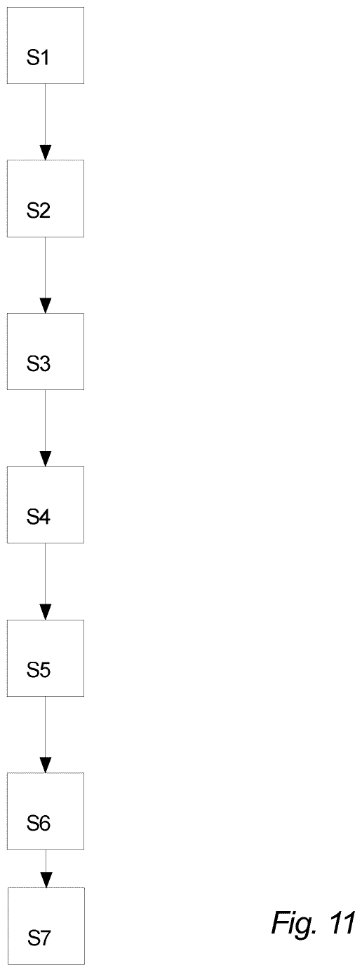

FIG. 11 illustrates a flow chart of a method according to the present invention of determining the area moment of inertia required to withstand a short circuit current and how a conductor has to be designed to have such area moment of inertia. The steps are described in greater details in relation to the description of FIG. 1b.

In a first step S1 a short circuit current is determined for the electrical system. This current creates an electromagnetic field around the conductor and the force F from this field is calculated in step S2. The electromagnetic force F is possible to calculate based on magnitude of short circuit current and distance between the two conductors. Then in step S3, it is possible to calculate the bending moment M a conductor is exposed to from this force F. Then in step S4, it is possible to calculate the area moment of inertia MI. For a given material having a specific Youngs Modulus E and Yield Point σ together with the bending moment M. From the area moment of inertia MI it is possible in step S5 to derive e.g. width and height of the conductor so that the conductor has the required area moment of inertia. In step S6, a check may be made to ensure that a conductor as determined in the previous steps does not deflect more than an allowed distance. Deflection below an allowed distance is to ensure that the conductor does not e.g. collide with another conductor or other components e.g. in an electric cabinet. Finally, in step S7, the conductor is manufactured. The manufacturing step according to the present invention preferably includes manufacturing the conductor by additive manufacturing.

The manufacturing of the electrical conductor may be done by an additive manufacturing process. Such manufacturing process may be based on, but not limited to, one of the following additive manufacturing processes: 3D printing, layer by layer printing, Wire Arc Additive Manufacturing, Fused Deposition Modeling FDM, Direct Energy Deposition, Direct Metal Deposition, sintering based processes, laser based processes, for example Powder Bed Fusion PBF, such as selective laser melting SLM or selective laser sintering SLS, cold spray additive manufacturing CSAM, binder jetting or binder jet 3D printing, etc. It should be mentioned that the actual additive manufacturing process used to print or build the electrical conductor may not be important as long as the material of which the electrical conductor is built is an electrically conductive material.

Following the additive manufacturing process of manufacturing a conductor according to the present invention it is possible to design conductors with different types of outgrowths having different purposes. One example is an outgrowth that functions as a heat sink, an air guide, a thermal bank (addition of material), a fuse (reduction of material), etc.

A thermal bank may be advantageous in that heat is extreme in a short circuit situation. A temperature increase of a couple of thousand degrees in milliseconds in a thin wire is expected due to short circuit currents in the range of e.g. 100-200 kA.

The different area moment of inertia of two conductor sections of the same conductor (with respect to the same reference axis) may result in a non-uniform geometry of the conductor. Alternative, a non-uniform conductor may be understood as a conductor having sections that are closer to a neighbouring conductor than other sections.

A reference to high-power system should be understood as an electrical systems, e.g. from 10 kW and up, such as 22 kW, 50 kW, 110 kW, 150 kW, 225 kW, 300 kW, 350 kW, 500 kW, 800 kW, 1 MW, 2 MW, 3 MW, or even higher, such as e.g. 5 MW or 10 MW systems, with voltages of e.g. 110V, 230V, 400V, 690V, 800V, 1000V, 1500V, 6 kV or e.g. 10 kV, and currents from e.g. 16 A, 32 A or 64 A, to several hundreds, e.g. 100 A, 200 A or 500 A, or even thousands, e.g. 1000 A to 4000 A.

According to the present invention, it is possible to design and manufacture, e.g. by additive manufacturing, a conductor having a first conductor section with a first geometry having an area moment of inertia facilitating flexing of said electrical conductor section in a predetermined direction during impact of a short circuit current. The same conductor may have a second conductor section with a moment of inertia facilitating melting due to the heat of a short circuit current or facilitating absorbing such heat. Accordingly, the area moment of inertia is predetermined, calculated based on facts related e.g. to current, dimensions, distance to fastening points, etc.

The term monolithic is in this description used to describe the geometry or structure of an electrical conductor according to an embodiment of the present invention. Such conductor is preferably manufactured by an additive manufacturing process and thereby, it is manufactured as a single piece, unit or block from one end to the other or at least one end and a conductor section is manufacture as a single piece. Such conductor may thus be formed from a single material as a single piece, unit or block where its one or more ends are monolithically formed with a conductor section connecting the one or more ends. I.e. monolithically formed should be understood as made in one continuous process with no need for additionally adding one part/conductor section to another. I.e. one or more ends are manufactured together with the conductor section as one unit with no connections such as welding, soldering, or by any clamping or fastening means, except for the type of micro binding intrinsic to the particular additive manufacturing technology utilized, such as, e.g., layer-by-layer melting, sintering, liquid binding, spraying, etc. With this said, it should be mentioned, that it is possible to add additional elements such as terminals, cooling fins, etc in a post manufacturing process e.g., by a cold spray process.

### List

EC. Electrical Conductor
1EC. First Electrical Conductor
2EC. Second Electrical Conductor
3EC. Third Electrical Conductor
AEC. Auxiliary Electrical Conductor
IEC. Independent Electrical Conductor
1IEC. First Independent Electrical Conductor
2IEC. Second Independent Electrical Conductor
3IEC. Third Independent Electrical Conductor
CS. Conductor Section
1CS. First Conductor Section
2CS. Second Conductor Section
3CS. Third Conductor Section
TCS. Transition Conductor Section
1-1EC. First Conductor Section of First Electrical Conductor
1-2EC. First Conductor Section of Second Electrical Conductor
1-3EC. First Conductor Section of Third Electrical Conductor
1-2EC. First Conductor Section of First Electrical Conductor
2-2EC. Second Conductor Section of Second Electrical Conductor
2-3EC. Second Conductor Section of Third Electrical Conductor
1SP. First Section Part
2SP. Second Section Part
1E. First End
2E. Second end
FA. Fastening Area
SS Support Structure
CB. Conductor Branch
CSS. Conductor Support Structure
CP. Current Path
D. Distance
1D. First Distance
2D. Second Distance
TB. Thermal Bank
MI. Moment of Inertia
TS. Transition Section
MP. Mounting Point
C. Centroid
CL. Clamp
B. Bolt
IS. Insulator

1.-54. (canceled)

55. An electrical conductor configured for being fastened to a support structure at one or more fastening areas, the electrical conductor comprising:
a first end and a second end,
wherein the one or more fastening areas separate the electrical conductor in two or more conductor sections each having an area moment of inertia with respect to a reference axis,
wherein a first conductor section of the two or more conductor sections has a first area moment of inertia,
wherein a second conductor section of the two or more conductor sections has a second area moment of inertia with respect to the reference axis which is different from the first area moment of inertia, and
wherein the first end and the second end are monolithically connected so as to form the electrical conductor in one piece.

56. The electrical conductor according to claim 55, wherein the electrical conductor is part of a distribution system of an electric panel supplying electric components with electrical power via auxiliary electrical conductors.

57. The electrical conductor according to claim 55, wherein the two or more conductor sections include, respectively, mass in excess of what is needed to conduct a nominal current of the two or more conductor sections.

58. The electrical conductor according to claim 55, wherein the two or more conductor sections include, respectively, a first section part and a second section part,
wherein the first section part is a current conducting part forming a main current path through the respective two or more conductor sections, and
wherein the second section part is a conductor support structure part increasing areas moment of inertia for the respective two or more conductor sections.

59. The electrical conductor according to claim 55, wherein the electrical conductor has a conductor support structure which is monolithically formed from the electrical conductor, and
wherein the conductor support structure is non-parallel to a current path from the first end to the second end of the electrical conductor.

60. The electrical conductor according to claim 55, wherein:
the first conductor section has a first geometry,
the second conductor section has a second geometry,
the first geometry is different from the second geometry, and
the first geometry and/or the second geometry is selected as one of: a cylindrical geometry, a multi-angular geometry, a lattice geometry, and a bionic geometry.

61. The electrical conductor according to claim 55, wherein a geometry of a conductor section of a first electrical conductor includes a plurality of conductor branches, and
wherein a distance between at least two of the plurality of conductor branches to a second electrical conductor changes along a length of the respective two or more conductor sections.

62. The electrical conductor according to claim 61, wherein the plurality of conductor branches are twisted.

63. The electrical conductor according to claim 61, wherein the plurality of conductor branches is physically connected via a high impedance connection.

64. The electrical conductor according to claim 60, wherein the first geometry includes a conductor branch which is non-parallel to a current path between the first end and the second end.

65. The electrical conductor according to claim 55, wherein:
a first conductor section of a first electrical conductor and a second electrical conductor are physically located at least partly in parallel with a first distance therebetween,
a second conductor section of the first electrical conductor has a second distance to the second electrical conductor which is smaller than the first distance, and
an area moment of inertia of the second conductor section of the first electrical conductor is higher than an area moment of inertia of the first conductor section of the first electrical conductor.

66. The electrical conductor according to claim 55, wherein at least one of the one or more fastening areas are monolithically connecting:
the first end to the second end, or
the first end to one of the two or more conductor sections, or
the second end to one of the two or more conductor sections, or
the second end to one of the two or more conductor sections.

67. The electrical conductor according to claim 55, wherein at least one of the one or more fastening areas includes a mounting piece configured to connect the electrical conductor to the support structure.

68. The electrical conductor according to claim 55, wherein the electrical conductor has a plurality of thermal banks distributed between the first end and the second end.

69. The electrical conductor according to claim 55, wherein a distance between two of the two or more conductor sections is less than 15 cm.

70. A high-power electrical system comprising:
two or more independent electrical conductors,
wherein:
at least one of the two or more independent electrical conductors is a first independent electrical conductor that includes a first end and a second end,
the first independent electrical conductor is configured for being fastened to a support structure at one or more fastening areas, the one or more fastening areas separating the first independent electrical conductor in two or more conductor sections,
a first conductor section of the two or more conductor sections of the first independent electrical conductor has a first area moment of inertia with respect to a reference axis, and
a second conductor section of the two or more conductor sections of the first independent electrical conductor has a second area moment of inertia with respect to the reference axis, which is different from the first area moment of inertia.

71. The high-power electrical system according to claim 70, wherein a conductor section of the first independent electrical conductor has a geometry establishing an area moment of inertia optimized to stabilize the first independent electrical conductor from a force acting in a first direction, and wherein a conductor section of a second independent electrical conductor has a geometry establishing an area moment of inertia optimized to stabilize the second independent electrical conductor from a force acting in a second direction, wherein the first direction is opposite the second direction.

72. The high-power electrical system according to claim 70, wherein a first conductor section (1CS) of the first independent electrical conductor (1IEC) is spaced from a second independent electrical conductor (2IEC) with a first distance (1D),
wherein a second conductor section (2CS) of the first independent electrical conductor (1IEC) is spaced from the second independent electrical conductor (2IEC) with a second distance (2D),
wherein the first distance (1D) is different from the second distance (2D).

73. A method of designing a first electrical conductor with a first end and a second end that are monolithically connected so as to form a first electrical conductor in one piece, the first electrical conductor being designed according to a physical location thereof in a high-power electrical system relative to a second electrical conductor, the method comprising steps of:
establishing minimum physical distance between the first electrical conductor and the second electrical conductor, and defining an area around the location of the first electrical conductor at the minimum physical distance as a minimum conductor section,
establishing a force occurring from at least one short circuit current at the minimum conductor section,
establishing a bending moment of the minimum conductor section of the first electrical conductor provided by the force,
establishing an area moment of inertia with respect to a reference axis of the minimum conductor section based on the bending moment and based on a maximum allowed stress of the minimum conductor section, and
establishing a required length and height of the minimum conductor section based on the area moment of inertia,
wherein the required length and height of the minimum conductor section is different from a length and height of an additional conductor section of the electrical conductor.

74. The method according to claim 73, wherein the maximum allowed stress is a yield point of a material of which the first electrical conductor is made.
